(19) United States
(12) Patent Application Publication
(10) Pub. No.: US 2025/0343795 A1
(43) Pub. Date: Nov. 6, 2025

(54) MULTI-AGENT IDENTITY GOVERNANCE AND ADMINISTRATION SYSTEM

(71) Applicants: Subramanian Rama, Irving, TX (US); Suraj Ranganath, Bangalore (IN); Anish Raghavendra, Bangalore (IN); Dalwinderjeet Grewal, Cedar Park, TX (US)

(72) Inventors: Subramanian Rama, Irving, TX (US); Suraj Ranganath, Bangalore (IN); Anish Raghavendra, Bangalore (IN); Dalwinderjeet Grewal, Cedar Park, TX (US)

(21) Appl. No.: 19/194,684

(22) Filed: Apr. 30, 2025

Related U.S. Application Data
(63) Continuation-in-part of application No. 19/055,635, filed on Feb. 18, 2025.
(60) Provisional application No. 63/641,397, filed on May 1, 2024.
(60) Provisional application No. 63/641,400, filed on May 1, 2024.
(60) Provisional application No. 63/641,395, filed on May 1, 2024.
(60) Provisional application No. 63/641,391, filed on May 1, 2024.
(60) Provisional application No. 63/641,383, filed on May 1, 2024.
(60) Provisional application No. 63/641,516, filed on May 2, 2024.
(60) Provisional application No. 63/641,917, filed on May 2, 2024.

(51) Int. Cl. H04L 9/40

(52) U.S. Cl. CPC H04L 63/10

(57) ABSTRACT

A multi-agent identity security governance and administration system including a network of intelligent agents deployed by the system. Each intelligent agent specializes in at least one distinct aspects of identity security. Each of the intelligent agents operate collaboratively to enforce access policies, detect anomalies, manage user privileges, and ensure compliance with regulatory requirements. The system leverages multi-agent technology in operations performed by the system.

### CROSS-REFERENCE TO RELATED APPLICATIONS

This application is a Utility patent application claiming priority to U.S. patent application Ser. No. 19/055,635, filed on Feb. 18, 2025, which claims priority to U.S. Provisional Patent Application Ser. No. 63/641,397, filed on May 1, 2024, U.S. Provisional Patent Application Ser. No. 63/641,516, filed on Sep. 30, 2024, U.S. Provisional Patent Application Ser. No. 63/641,917, filed on May 1, 2024, U.S. Provisional Patent Application Ser. No. 63/641,400, filed on May 1, 2024, U.S. Provisional Patent Application Ser. No. 63/641,395, filed on May 1, 2024, U.S. Provisional Patent Application Ser. No. 63/641,391, filed on May 1, 2024, and U.S. Provisional Patent Application Ser. No. 63/641,383, filed on May 1, 2024, which are incorporated by reference herein in their entirety.

### COPYRIGHT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### 1) Field of the Invention

The invention relates to the field of Multi-A gent Identity Security Governance and Administration, and more particularly to a system or tool for automating all aspects of identity security management.

### 2) Description of Related art

One problem with identity governance and administration (IGA) is that identity governance and administration involves managing complex and multi-faceted data. For example, an employee can have multiple identities, and these identities might have access to various resources in various applications via memberships or connections. These identities are not just static entities; they include critical insights such as whether they have access to privileged connections & permissions, sensitive resources, if they stand out as outliers, or if they are over-entitled. Similarly, employees, applications, connections, and resources come with their own insights, adding layers of complexity. The highly relational nature of this data makes rigid web interfaces restrictive when users attempt to explore it in more detail. Accessing and extracting meaningful information from this kind of data often requires a strong grasp of specific query languages. This creates a significant barrier for users who might not be familiar with these technical languages but still need to make data-driven decisions. To bridge this gap, what is needed is an artificial intelligence (AI) system that a user can interact with to learn more about the state of their identity security and take action when required. Additionally, given the complexity of IGA data, there's a clear need for differentiated dashboards and custom reports to allow users to visualize and manage this information effectively.

### BRIEF SUMMARY OF THE INVENTION

A multi-agent identity security governance and administration system including a network of intelligent agents deployed by the system. Each intelligent agent specializes in at least one distinct aspects of identity security. Each of the intelligent agents operate collaboratively to enforce access policies, detect anomalies, manage user privileges, and ensure compliance with regulatory requirements. The system leverages multi-agent technology in operations performed by the system.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 shows a diagram of the multi-agent identity security governance and administration system according to the present disclosure.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

A multi-agent identity security governance and administration (IGA) tool is a comprehensive solution designed to automate all aspects of identity security management. The related platform uses cutting-edge multi-agent technology, deploying a network of intelligent agents specializing in various aspects of identity security. These agents work together to enforce access policies, detect anomalies, manage user privileges, and ensure compliance with regulations. By combining AI algorithms and distributed computing, the tool offers real-time monitoring, adaptive authentication, and automated responses to effectively handle security risks. With the multi-Agent IGA tool, organizations can achieve robust identity security governance without manual intervention, enhancing operational efficiency and reducing security vulnerabilities. The advanced multi-A gent IGA tool not only simplifies identity security governance but also reduces the risk of security breaches, thereby ensuring an organization's safety, efficiency, and growth.

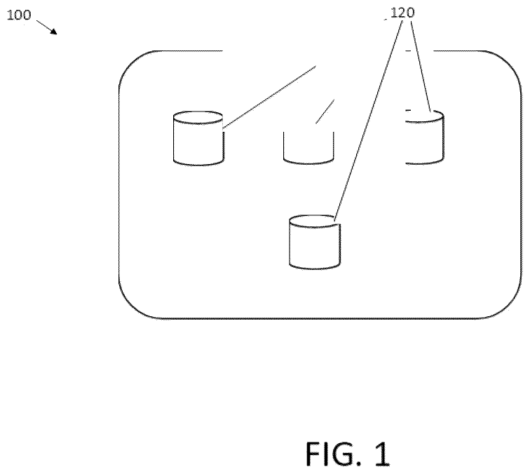

FIG. 1 shows a diagram of the an advanced Multi-A gent Identity Security Governance and Administration (IGA) system 100, which is a comprehensive solution designed to automate and streamline all facets of identity security management. This platform leverages multi-agent technology, deploying a network of intelligent agents 120, each specializing in distinct aspects of identity security. These agents operate collaboratively to enforce access policies, detect anomalies, manage user privileges, and ensure compliance with regulatory requirements. The system dynamically provisions and de-provisions least privilege connections (high-confidence roles) based on continuous real-time risk assessment, ensuring that least privilege access is always maintained. Functioning autonomously in the background, much like modern antivirus or endpoint detection and response systems, the platform safeguards identities without requiring user intervention.

Access for new joiners is automatically provisioned, role updates trigger purpose adjustments and re-provisioning, and access for movers and leavers is managed automatically. This applies to both human and non-human identities, including service accounts. Extending beyond traditional identity management systems, this solution introduces autonomous agents capable of continuous management of identity security. With the Multi-A gent IGA system, organizations achieve enhanced operational efficiency, minimized security vulnerabilities, and comprehensive identity security governance, significantly reducing the risk of security breaches and supporting the organization's growth in a secure manner.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various disk drives (HDD, SSD), CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

In one aspect of the disclosure a method to implement access control for data retrieval by AI assistants is described. The method for accessing control for data retrieved by AI Assistants addresses the critical challenge of unauthorized data access and leakage, a prevalent issue as AI Assistants become more integrated into various information systems. It ensures secure and compliant data handling by embedding control mechanisms directly within the AI models, thereby preventing unauthorized access to sensitive information. By introducing an intermediate layer of security, it addresses the gap in current systems where AI Assistants may inadvertently bypass traditional data protection measures. The invention introduces an access control layer between LLMs and their data sources. The access control layer resides in the LLM rather than the data source thus ensuring that the assistant can access multiple data sources flexibly. This ensures that users of these assistants only access information that they are entitled to access according to their role, group, or individual privileges.

In one aspect of the disclosure autonomous access reviews employing cutting-edge generative AI technologies represents a groundbreaking leap forward in the approach to compliance management. By harnessing the power of artificial intelligence, we are poised to revolutionize the way we conduct access reviews, enabling us to stay ahead of regulatory requirements and industry standards. This innovative solution empowers us to proactively identify and address potential compliance issues before they escalate, thereby minimizing risk and ensuring the integrity of the systems and data.

Through the seamless integration of advanced machine learning algorithms, the organization can achieve unparalleled efficiency and accuracy in access review processes, ultimately enhancing security, fostering trust, and maintaining a competitive edge in today's rapidly evolving regulatory landscape.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A multi-agent identity security governance and administration system comprising:
a network of intelligent agents deployed by the system, each intelligent agent specializing in at least one distinct aspects of identity security;
wherein each of the intelligent agents operate collaboratively to enforce access policies, detect anomalies, manage user privileges, and ensure compliance with regulatory requirements; and
wherein the system leverages multi-agent technology in operations performed by the system.
